(19) United States
(12) Patent Application Publication
(10) Pub. No.: US 2006/0178832 A1
(43) Pub. Date: Aug. 10, 2006

(54) Device for the temporal compression or expansion, associated method and sequence of samples

(76) Inventor: Gonzalo Lucioni, Witten (DE)

Correspondence Address: Siemens Corporation;Intellectual Property Department, 170 Wood Avenue South, Iselin, NJ, 08830, US

(21) Appl. No.: 10/560,840

(22) PCT Filed: Apr. 27, 2004
(86) PCT No.: PCT/EP04/50617

§ 371 Date: Dec. 15, 2005

(30) Foreign Application Priority Data
Jun. 16, 2003 (DE) 103 27 057.4

(51) Int. Cl. G06F 19/00; G06F 17/15

(52) U.S. Cl. 702/19; 708/422

(57) ABSTRACT

A device comprising an input memory, in which samples to be processed are stored, in addition to a control unit, which controls a temporal compression or expansion of the sequence of samples in a cyclic manner based on a conversion factor is provided. A skew unit is linked on the input side to the output of the input memory. During a working cycle, a merge unit merges a filtered sequence of samples that has been generated from the original sequence of samples by means of a filter unit with a time-staggered sequence that has been generated with the aid of the skew unit and subsequently filtered. Despite the simple construction of the device, there are no discernible or only faint artifacts.

### CROSS REFERENCE TO RELATED APPLICATIONS

This application is the US National Stage of International Application No. PCT/EP2004/050617, filed Apr. 27, 2004 and claims the benefit thereof. The International Application claims the benefits of German application No. 10327057.4 DE filed Jun. 16, 2003, both of the applications are incorporated by reference herein in their entirety.

### FIELD OF INVENTION

The device contains an input memory in which samples to be processed are stored, and a control unit, which controls a temporal expansion or compression of the sequence of samples in a cyclic manner based on a conversion factor.

### BACKGROUND OF INVENTION

One such device is for example well known from DE 100 06 245 A1. In addition to the conversion method mentioned in said document for time scaling, in the past 50 years, numerous other methods have been proposed. However, with respect to a compromise between the required computer capacity and the quality achieved, extremely few of these methods are satisfactory. In particular, methods with Fourier transformation or the calculation of cross correlations are computer-intensive. Other methods are indeed very simple, but lead to audible artifacts.

With time-scale conversion devices, audio data can be converted in such a way that the time duration of the audio signals represented by the audio data changes while extensively maintaining its tone pitch. A plurality of methods for the conversion of the time scale, for the time being, carries out an analysis of the audio data in order to determine the parameters. Processing only starts after the analysis has been implemented. The analysis is carried out in a time window, the span of which orients itself to the characteristics of human hearing and even to the voice characteristics, i.e. in a time window in the order of magnitude of a few hundredth seconds, for example, in a time window between 20 and 40 ms (milliseconds), in particular 30 ms. The analysis also delays the audio flow to be converted, so that the speech quality, in particular with respect to the occurrence of audible echoes, is reduced. As a result, the advantage of the time-scale conversion device is often smaller than the disadvantages associated with it. This statement in particular applies to the synchronization of the sampling rate by means of time-scale conversion devices in the case of a mismatching of the pulse of the communicating devices in a data transmission network. However, the mismatching is mostly negligible and is usually less than 10 percent; however, the delay generated by the conversion is audible for a speaker.

### SUMMARY OF INVENTION

An object of the invention is to create a simply constructed device for compression and/or expansion of the time scale of the sequence of samples. The device should in particular be suitable for expansions or compressions by less than 10 percent. The expansion or compression should also not reduce the quality of voice signals or music signals. The device should in particular operate without an analysis of the audio data in order not to delay a real time processing any further. In addition, both a method for compression and expansion and a sequence of samples should be given.

The device in accordance with the invention, in addition to the above-mentioned units, also contains the following:
a skew unit that is linked on the input side to the output of the input memory and that, referred to the sample processed in one working step of the sequence, determines a sample by an offset number that follows, i.e. delayed, or precedes in the sequence by an offset number,
a merge unit which, on the one hand, merges a filtered sequence of samples that have been generated from the original sequence of samples by means of a filter unit with a time-staggered sequence that has been generated with the aid of the skew unit and subsequently filtered on the other hand.

In addition, a device in accordance with the invention contains a working cycle of a predetermined number of working steps for processing a sub-sequence of the sequence of samples. Because of this, the length of a working cycle need not be determined anew continuously.

Therefore, the device in accordance with the invention makes do without an analysis window and is in this way suitable for all the applications of conversion devices, in particular, for real time applications such as real time communication. In particular, the device for the synchronization of the sampling rate of the audio data of packet-oriented terminals is suitable, for example, of Internet terminals, which operate in accordance with the Internet protocol.

In the case of other further developments, the device contains only coefficient default units, multiplication units and delay units, i.e. only a few different units that can be implemented in an easy manner via wiring or software.

In the case of additional further developments of the device, the voice quality is further increased by:
the inclusion of additional coefficient functions, auxiliary functions and additional delay units, or by
the inclusion of an all-pass.

In the next further development, the device is constructed as a pure electronic circuit without a processor. In this case, the processing times compared with the processing times when including a processor are very short. However, as an alternative a processor is used in order to reduce the circuitry involved.

In addition, the invention concerns a method for the temporal compression and expansion, which in particular can be embodied with the device in accordance with the invention or one of its further developments. In this way, the above-mentioned technical actions also apply to the method and its further developments.

In addition, the invention also relates to a sequence of samples which have been generated with the device in accordance with the invention or the method in accordance with the invention. The above-mentioned technical actions also apply to the sequence of samples.

### BRIEF DESCRIPTION OF THE DRAWINGS

The invention is explained in detail below with reference to the accompanying drawings and on the basis of the embodiments. They are as follows:

FIG. 1 a block diagram of a conversion device,

FIG. 2 a conversion device with one delay unit,

FIG. 3 a conversion device with two delay units,

FIG. 4 a conversion device with a delay unit and an all-pass, and

FIG. 5 the transmission functions for the overlapping and addition function of the different conversion units.

### DETAILED DESCRIPTION OF INVENTION

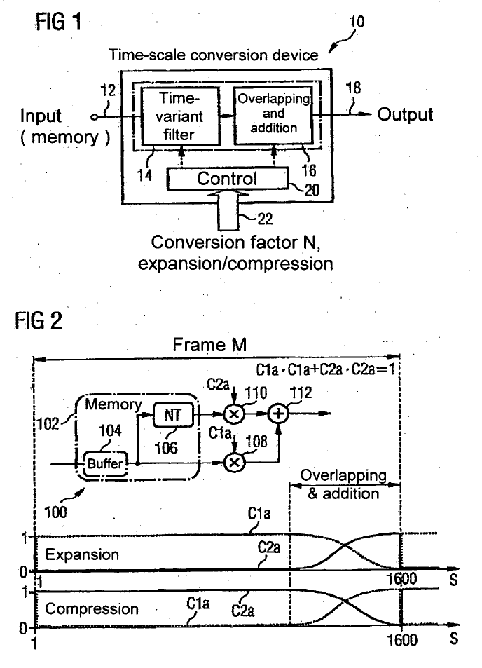

FIG. 1 shows a block diagram of a conversion device 10, which is used for the temporal expansion or the temporal compression of voice signals. In other words, by using the conversion device 10, the playback speed may vary from voice data to real time, without for example the tone pitch of the voice signal changing in any way. There are also no audible artifacts.

The conversion device 10 has an input 12 for entering the samples of a voice signal, which has for example been sampled with a frequency of eight kilohertz. The samples are, for example, in the integral range between −32768 and +32767. The input 12 leads to a filter unit 14, which for the input values or for the time-staggered input values carries out filter functions in accordance with the predetermined coefficients. The coefficients change time-dependent so that a filtering varying in time is present.

An overlapping and addition unit 16 is connected downstream of the filter unit 14 which merges two sequences of samples output by the filter unit 14, which will be explained in greater detail below. The overlapping and addition unit outputs a sequence of results at an output 18.

In addition, the conversion device 10 contains a control unit 20, which based on a conversion factor N and a selection signal, activates the filter unit and the overlapping and addition unit in such a way that the sequence of samples at the output 18 is temporally stretched or temporally compressed in comparison with the sequence at the input 12. In this case, N is a natural number.

In the case of another embodiment, the filter unit of the overlapping and addition unit is connected downstream in such a way that first a non-delayed sequence and then a delayed sequence are overlapped. Only after the overlapping, artifacts generated by the overlapping are cleared again for example with a suitable window function or with a time-variant attenuator.

FIG. 2 shows a conversion device 100, which contains a memory unit 102, for example, a RAM memory (Random Access Memory) or a FIFO memory (First In First Out). The memory unit 102 contains an input memory 104, in which arriving samples are stored intermediately.

Furthermore, the conversion unit 100 contains a delay unit 106 which, referred to a sample to be processed in a working step s, determines a sample from the memory unit which has been delayed by N samples to the sample actually to be processed. The delay can be implemented by means of the suitable reading out of the memory unit 102, for example by an address offset by N or a multiple of N.

In addition, the conversion device 100 contains a multiplication unit 108, which is linked to the output of the input memory 108. The other input of the multiplication unit 108 is linked to a coefficient default unit, which specifies coefficients in accordance with a coefficient function C1a. The multiplication unit 108 calculates the product of their input values in each working step s.

An additional multiplication unit 110 is linked on the input side to the output of the delay unit 106 and the coefficient default unit, which specifies coefficients in accordance with a coefficient default function C2a. The course of the coefficient functions C1a and C2a is shown in the center part of FIG. 2 for the expansion or in the lower part of FIG. 2 for the compression and is explained in detail further below. The multiplication unit 110 calculates the product of their input values for each working step.

An addition unit 112 is linked on the input side to the outputs of the multiplication units 108 and 110. The addition unit 112 calculates the sum of their input values.

The course of the coefficient functions C1a and C2a for the expansion is shown in the center part of FIG. 2. The values of the coefficient functions C1a and C2a are between 0 and 1. At first, the coefficient C1a constantly has the value 1. Only in the last section, more precisely in the last third of a working cycle M of for example 1600 working steps s, the coefficient function C1a is strictly monotone, for example, as shown in accordance with a function, which is similar to the sigmoid function or also in a linear manner. On the other hand, the coefficient C2a on expansion then constantly at first has the value 0. Only in the last section the coefficient function C2a increases strictly monotone, for example, as shown in accordance with a function, which is similar to a sigmoid function or even in a linear manner.

This means that in the first section of a working cycle M, on expansion, the non-delayed sequence of samples is output. In the last section there is then a gradual changeover to the delayed sequence because of the coefficient courses. The gradual transition then spreads out over a plurality of working steps s, in particular over more than 100 working steps s and less than 800 working steps s. Expressed more in general, the transition is in a section, which contains more than five percent and less than fifty percent of the working steps of a working cycle. Finally, for expansion an “echo” is appended that is, however, on account of the gradual transition because of the too short time span, which the samples of a working cycle M contain and on account of the moderate expansion factors not audible or only faintly audible. In the embodiment, a working cycle referred to the processed values comprises more than 200 ms (milliseconds) and less than 1000 ms. It is expanded 10 percent max. In this way, at least six basic voice units of approximately 30 ms are in each case processed in a working cycle M.

The course of the coefficient functions C1a and C2a for the compression is shown in the bottom part of FIG. 2. The values of the coefficient functions C1a and C2a are again between 0 and 1. At first, the coefficient C2a constantly has the value 1. Only in the last section, more precisely in the last third of a working cycle M the coefficient function C2a is strictly monotone, for example, as shown in accordance with a function, which is similar to the sigmoid function or also in a linear manner. On the other hand, the coefficient C1a on expansion then constantly at first has the value 0. Only in the last section the coefficient function C1a increases strictly monotone, for example, as shown in accordance with a function, which is similar to a sigmoid function or even in a linear manner.

This means that in the first section of a working cycle M, the delayed sequence of samples is output when a compression is implemented. In the last section, because of the coefficient courses, there is a gradual switching over to the non-delayed sequence. Finally, for compression a part of the samples is “suppressed”. However, based on the above-mentioned reasons this is only faintly audible. Because of the gradual transition, the “suppressed” samples also have an effect on the generated output signal.

For the coefficient functions C1a and C2a, the following relation also applies:
(C1a)²+(C2a)²=1,
in which case the signal power of the voice signals and the music signals remains unchanged on average and in essence.

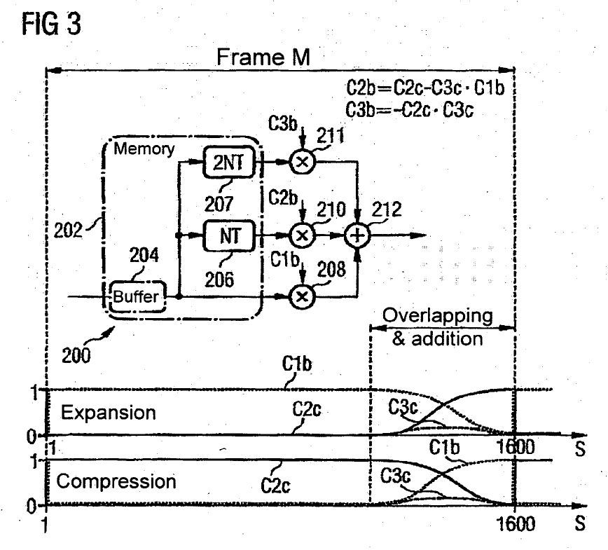

FIG. 3 shows a conversion device 200 with two delay units 206 and 207. A first part of the conversion unit 200 corresponds structurally and in accordance with its function to the conversion device 100. Because of this, the elements of this part are not explained again and in FIG. 3 have the same reference symbols as in FIG. 2, but in each case increased by the value 100. However, instead of the coefficient function C1a or C2a, the coefficient functions C1b and C2b whose course is explained in detail below are used.

Unlike the conversion device 100, the conversion device 200 still contains an additional delay unit 207, however delayed by double as the delay unit 106 or 206, i.e. by 2*N. The input of the delay unit 207 is linked to the output of the input memory 204. The output of the delay unit 207 is linked to the input of a multiplication unit 211. The other input of the multiplication unit 211 is linked to a coefficient default unit, which specifies the coefficients in accordance with a coefficient function C3b whose course is explained in detail below.

The input of the addition unit 212 is linked to both the outputs of the multiplication unit 208 and 208 and the output of the multiplication unit 211. The expanded or compressed sequence of samples is output at the output of the addition unit 212.

The course of the coefficient function C1b and two auxiliary functions C2c and C3c is shown in the center part of FIG. 3 for expansion and in the lower part of FIG. 3 for compression. The course of the coefficient function C1b corresponds to the course of the coefficient function C1a, see explanations to FIG. 2. The course of the auxiliary function C2c for expansion and compression in each case corresponds to the course of the coefficient function C2a for expansion and compression, see explanations to FIG. 2. The auxiliary function C3c in the first two thirds of a working cycle M has the value 0. In the last third, the auxiliary function C3c increases strictly monotone to a maximum value of approximately 0.3, then to decrease again strictly monotone to the value 0. The auxiliary function C3c has its maximum in a working step s, in which the coefficient function C1b has the same value as the auxiliary function C2c.

For the coefficient functions C2b and C3b, the following applies:
C2b=C2c−C3c*C1b,
C3b=−C2c*C3c.

In the case of another embodiment, the following relations also apply:
(C1b)²+(C2c)²=1.
(C1b)+(C2b)+(C3b)=1,
in which case the signal power of the voice signals and the music signals remains unchanged on average and in essence and specific tones likewise also remain unchanged, for example tones with a gyrofrequency of 2 PI k/N, in which case the PI, the number PI and k are a natural number.

The conversion device 200 can also be shown in an equivalent manner by using two parallel switched equalizers in accordance with the conversion device 100. The input of the one equalizer branch is linked to the output of the input memory 204. The equalizer is controlled with the coefficient functions C1b and C2c. The input of the other equalizer branch is likewise linked to the output of the input memory 204. The second equalizer branch contains a parallel connection from an additional delay unit for a delay N and from an equalizer unit in accordance with the conversion device 100. The second equalizer is likewise controlled with the coefficient functions C1b and C2c. In addition, the second equalizer branch contains a multiplication unit where the coefficient function C3c is present at its other input. Both equalizer branches are linked via a balancing circuit in which case the result of the second equalizer branch is deducted from the result of the first equalizer branch in each working step s.

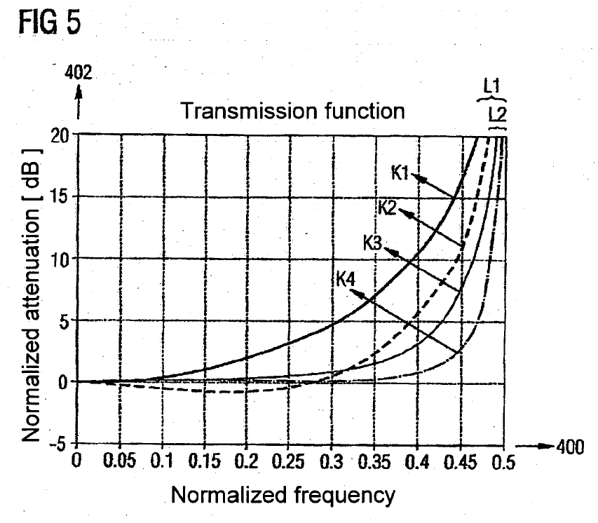

Improved results are achieved by the conversion device shown in FIG. 3, which is explained in detail in association with FIG. 5. In particular, a type of notch filter with smaller frequency gaps compared with the conversion device 100 is developed. These results can further be improved in a similar way by introducing additional delay units and coefficients.

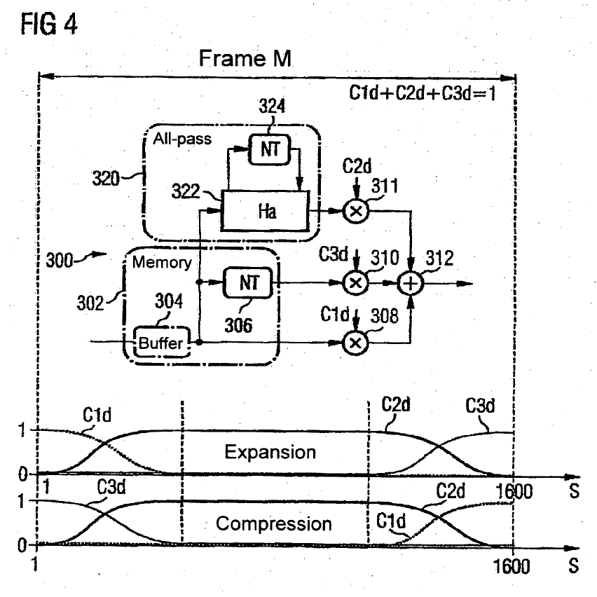

FIG. 4 shows a conversion device 300 with a delay unit 306 and an all-pass 320 of the first order and a first part of the conversion device 300 is constructed in the same way as the conversion device 100 and also functions in the same way. Because of this, the elements of this part are not explained again and in FIG. 4 have a reference symbol to which, taking the reference symbol in FIG. 2 as a starting basis, the value 200 has been added. However, in the place of the coefficient functions C1a and C2a the coefficient functions C1d and C3d are used whose course is explained in greater detail below.

Unlike the conversion device 100, the conversion device 300 also contains the all-pass unit 320. The all-pass unit 320 contains a filter unit 322 and a delay unit 324, which is delayed by N steps. The all-pass unit 320 has the following transmission function:
H=(z^{-N}+γ)/(1+γ*z^{-N}),
in which case H is the transmission function, γ determines a delay and γ in particular has the value 0.5 or a value exceeding 0.5.

The input of the all-pass unit 320 is linked to the output of the input memory 304. The output of the all-pass unit 320 leads to the one input of a multiplication unit 311. The other input of the multiplication unit 311 is linked to the output of a coefficient default unit, which for each working step s specifies coefficients in accordance with a coefficient default function C2d whose course for the two operating modes “expansion” and “compression” will still be explained in greater detail.

The output of the multiplication unit 311 leads to an input of the addition unit 312. The other inputs of the addition unit 112 are linked to the outputs of the multiplication units 308 and 310.

The values of the coefficient functions C1d, C2d and C3d lie between 0 and 1. The following applies to the coefficient functions C1d to C3d:
C1d+C2d+C3d=1
in which case specific tones likewise remain unchanged, for example, tones of a gyrofrequency of 2 PI k/N, in which case the PI, the number PI and k are a natural number.

In the operating mode “expansion”, the coefficient function C1d, in the first third of a working cycle, decreases strictly monotone from the value 1 to the value 0, for example, in accordance with a function, which is similar to or the same as a sigmoid function. For the following working steps s of the working cycle M, the coefficient function C1d remains at the value 0. In the operating mode “expansion”, the coefficient function C2d increases in the first third of a working cycle M from the value 0 to the value 1. In the second third, the coefficient function C2d constantly remains at the value 1. In the last third, the coefficient function decreases strictly monotone from the value 1 to the value 0. In the operating mode “expansion”, the coefficient function C3d in the first two thirds of a working cycle M constantly remains at the value 0. In the last third of a working cycle M, the coefficient function C3d increases strictly monotone from the value 0 to the value 1.

For the operating mode “compression”, the coefficient function C1d has the course of the coefficient function C3d in the operating mode “expansion”. The coefficient function C2d, in the operating mode “compression” has the same course as in the operating mode “expansion”. The coefficient function C3d, in the operating mode “compression” has the same course as the coefficient function C1d in the operating mode “expansion”.

FIG. 5 shows the transmission functions for the overlapping and addition function of different conversion units at places where there are frequency gaps. A horizontal x-axis 400 shows the normalized frequency in the range between 0 and 0.5. The course shown in FIG. 5 repeats itself for higher frequencies. A vertical y-axis 402 shows the normalized attenuation in dB in the range from −5 dB to 20 dB. A curve K1 applies to the conversion device 100, which can also be considered as the equalizer of the zeroth order. The conversion device 200 can be regarded as the equalizer unit of the first order. A curve K2 applies to the conversion device 200. With an increasing order of the equalizer, the attenuation decreases. In addition, a frequency gap L1 to L2, which applies to the curve K1 or K2 becomes smaller.

Curves K3 and K4 apply to the conversion device 300 with a γ value of 0.5 or 0.75. With an increasing y value, the frequency gap decreases further.

The conversion factor N, which specifies the number of delays, is for example specified depending on the occupancy of the input memory 104, 204 or 304. The same applies to the decision whether or not an expansion or a compression should be implemented. If the input memory for example empties too quickly, an expansion must be implemented. The quicker the input memory is emptied, the quicker an expansion has to be carried out, i.e. N is enlarged.

For all the explained embodiments it is applicable that the invention uses characteristics pertaining to human hearing, in accordance with which special types of artifacts cannot be distinguished or can only faintly be distinguished, in particular said artifacts which develop by using the above-mentioned overlapping method. The method operates in the time range with the aid of a fixed time frame, which divides the audio data into time segments, for example, into time segments of 200 ms. In order to convert the time scale, the original audio flow with a delayed version of its own is overlapped and added within a time segment in a section with a defined length for example of 30 ms. This takes place on the basis of selected coefficients so that no discontinuity develops. The delay is proportional to the conversion factor and corresponds to the delay between the audio flow at the input and output of the time-scale conversion device. The delay is for example between 0 ms and 20 ms in the case of a conversion factor from 0 percent up to 10 percent in the sense of time compression or time expansion. The selection of the above-mentioned time frame or time segment section likewise contributes to reducing the ability to distinguish the developing artifacts.

In the explained methods, the development of artifacts or audible interferences has already been counteracted and/or removed on merging the developing artifacts after the merging, for example, with a time-variant attenuator, which does not further increase the overall delay of the conversion device. A more costly digital filter leads to an improved quality, but usually increases the overall delay somewhat.

The explained methods:
are oriented to the characteristics of human hearing and make do without an analysis window,
can be introduced with small algorithmic delay times into the audio path,
can be implemented in a cost-effective manner,
can be used in real time applications on account of the small delays,
make possible a high-quality conversion both from voice and from music,
can be used in a plurality of applications, for example, for the synchronization of the sampling rate or for a dynamic jitter buffer adjustment,
can be combined with other time-based methods, for example, with the method in accordance with “MPEG-4 Audio, ISO/IEC FCD 14496-3, Subpart 1: Section 4.1.3” dated 15.05.1998, see, for example ftp://ftp.tnt.uni-hannover.de/pub/MPEG/ audio/mpeg4/documents/w2203/w2203.pdf.

In the case of alternative embodiments in accordance with FIGS. 2 and 3, the overlapping and addition ranges are not located at the, but at the beginning of a working cycle M, so that at the of a working cycle M there are then sections with constant coefficient functions and with constant auxiliary functions. In the case of other alternative embodiments in accordance with FIGS. 2 and 3, the overlapping and addition ranges are located in the center of a working cycle M so that at the of a working cycle M and at the beginning of a working cycle M there are then sections with constant coefficient functions and constant auxiliary functions.

In the case of alternative embodiments in accordance with FIG. 4, in addition to the two overlapping and addition sections with changing coefficient functions and auxiliary functions there are also two constant sections. Each section is for example one quarter of a working cycle M in length. Alternatively, sections with different lengths can also be used. If the overlapping and addition sections are abbreviated with an Ü and the constant sections with a K, this for example results in the following section sequences for each working cycle M:
Ü-K-Ü-K, or
K-Ü-K-Ü,
   in which case the temporal sequence of the sections shown in FIG. 4 on compression or expansion is retained.

1.-14. (canceled)

15. A device for the temporal expansion or compression of a sequence of audio samples in a data transmission network, comprising:
an input for receiving the sequence of samples of a signal;
a memory unit operatively connected to the input stores the samples;
a control unit that cyclically controls the temporal expansion or compression based on a conversion factor specifying a number of samples to delay;
a working cycle having a predetermined number of working steps for processing a sub-sequence of the sequence of samples;
a delay unit operatively connected to the input memory, the delay unit references the sample to be processed in one of the number of working steps, determines a delayed sample from the memory unit that has been delayed by the number of samples to delay in comparison to the sample to be processed;
a filter unit, comprising:
a first multiplication unit operatively connected to an output of the memory unit and to a first coefficient unit providing a first coefficient in accordance to a first coefficient function, the first multiplication unit providing an output of the product of the output of the memory unit and the first coefficient, and
a second multiplication unit operatively connected to an output of the delay unit and to a second coefficient unit providing a second coefficient in accordance to a second coefficient function, the second multiplication unit providing an output of the product of the output of the delay unit and the second coefficient; and
a merge unit merging the outputs of the first and second multiplication units,
wherein the first and second coefficients have a value between zero and one.

16. The device according to claim 15, wherein the first and second coefficient changing in time and wherein the square of the first coefficient plus the square of the second coefficient equals one.

17. The device according to claim 16, wherein the first coefficient starts with 1 at the beginning of the working cycle and changing in accordance to the first coefficient function wherein first coefficient changing linearly or in accordance with a sigmoid function.

18. The device according to claim 16, further comprising a time-variant attenuator filter connected down stream from the merge unit.

19. The device according to claim 18, wherein at least six audio units of approximately Ü 30 ms are processed in a working cycle.

20. The device according to claim 15, wherein the sub-sequences including at least fifty eight percent of all the samples of a sequence.

21. The device according to claim 15, wherein the processed sub-sequences including less than half of all the samples of a sequence.

22. The device according to claim 15, further comprising:
an additional delay unit operatively connected to the input memory, the additional delay unit determining a delayed sample twice that of the first delay unit, and an additional multiplication unit operatively connected to an output of the additional delay unit and to an additional coefficient unit providing an additional coefficient in accordance to a additional coefficient function, the additional multiplication unit providing an output of the product of the output of the additional delay unit and the additional coefficient, wherein the merge unit merging the outputs of the first, second, and additional multiplication units.

23. The device according to claim 22, wherein the second coefficient function equals a second auxiliary function minus the product of a third auxiliary function and the first coefficient function, and wherein the additional coefficient function equals the product of the negative of the second auxiliary function and the third auxiliary function.

24. The device according to claim 22, wherein the sum of the first, second and additional coefficient functions is equal to one.

25. The device according to claim 24, wherein the additional processing unit contains an all-pass with the following transmission function
H=(z^{-N}+γ)/(1+γ*z^{-N})
where H is the transmission function and γ determining a delay and γ has the value 0.5 or a value greater than 0.5.

26. The device according to claim 15, wherein the expansion or the compression is less than 20 percent.

27. A method for the temporal compression or expansion of a audio sequence of samples, comprising specifying a working cycle that contains a predetermined number of working steps;
specifying a sub-sequence of the sequence of samples for a working cycle;
generating during the working cycle a time-staggered sub-sequence that is time-staggered to the sub-sequence of samples; and
merging during the working cycle the sub-sequence with the time-staggered sub-sequence.

28. The method according to claim 27, wherein prior to merging the sub-sequence and the time-staggered subsequence the sub-sequence is filtered and/or the time-staggered subs-sequence is filtered.

29. The method according to claim 28, wherein the filter includes a first coefficient function and a second coefficient function, the coefficient functions changing over time in accordance with a linear function or a sigmoid function.

30. The method according to claim 28, wherein the square of the first coefficient function plus the square of the second coefficient function equals 1.

31. The method according to claim 29, further comprising:
generating an additional time-staggered sub-sequence, and
providing a third coefficient function changing over time in accordance with a linear function or a sigmoid function,
wherein merging during the working cycle the sub-sequence with the time-staggered sub-sequence includes merging the additional time-staggered sub-sequence.

32. The method according to claim 27, wherein the subsection includes less than one third of the working steps of a working cycle.

33. The method according to claim 27, wherein the method is associated with a device selected from the group consisting of a receiver unit of a data transmission network, a transmitter unit of a data transmission network, a music reproducing device, a dictating machine, a voice output unit and combinations thereof.
